(19) United States
(12) Patent Application Publication
(10) Pub. No.: US 2016/0322860 A1
(43) Pub. Date: Nov. 3, 2016

(54) POWER DISTRIBUTION SYSTEM AND ELECTRICAL SYSTEM

(71) Applicant: Delta Electronics (Shanghai) CO., LTD, Shanghai (CN)

(72) Inventors: Hongyang WU, Shanghai (CN); Xiaoming CHEN, Shanghai (CN); Feiqin HAO, Shanghai (CN); Cheng LU, Shanghai (CN); Tao GE, Shanghai (CN)

(73) Assignee: Delta Electronics (Shanghai) CO., LTD, Shanghai (CN)

(21) Appl. No.: 15/056,373

(22) Filed: Feb. 29, 2016

(30) Foreign Application Priority Data
Apr. 28, 2015 (CN) 201510210004.7

(51) Int. Cl. H02J 9/06

(52) U.S. Cl. CPC H02J 9/06

(57) ABSTRACT

A power distribution system is connected to a first power supply, a second power supply and an energy storage unit. The power distribution system includes: a selection switch, its movable terminal being connected to a load and selectively being electrically connected to its first fixed terminal; a first converter, its first terminal being electrically connected to the second power supply; a second converter, its first terminal being electrically connected to a second terminal of the first converter and electrically connected to the energy storage unit; a first switch, its first terminal being electrically connected to a second terminal of the second converter, and its second terminal being electrically connected to the first fixed terminal of the selection switch; and a second switch, its first terminal being electrically connected to the second terminal of the first switch, and its second terminal being electrically connected to the first power supply.

### CROSS REFERENCE TO RELATED APPLICATIONS

This application is based upon and claims priority under 35 U.S.C. §119 to Chinese Patent Applications No. 201510210004.7, filed on Apr. 28, 2015, the entire contents of which are incorporated herein by reference.

### TECHNICAL FIELD

The present disclosure generally relates to a power distribution system, and more particularly, to a power distribution system and an electrical system having a plurality of power supplies.

### BACKGROUND

Conventionally, a load may be supplied with power came from a single power supply which is composed of a power grid or a stand-alone power generation device. FIG. 1 shows a conventional power supply and distribution mode with a single power supply for a load. As shown in FIG. 1, the power supply Grid may represent a power grid or a stand-alone power generation device. The power supply Grid is connected to a switch K1 and a load in series. This configuration has a defect that the single power supply can not provide power under a sudden power failure.

Therefore, for an important load, two independent power supplies are usually provided, one of which is for normal power supply, the other serves as a backup power supply. FIG. 2 shows a conventional power supply and power distribution mode with double power supplies for a load. However, since the two independent power supplies Grid1 and Grid2 are not locally controlled, their amplitudes, frequencies, or phases may be different, and they are unable to supply power simultaneously, an interruption of power supply may occur during switching between the two power supplies. For an even more sensible and important load, an uninterrupted power supply (UPS) is usually adopted as a power supply mode. FIG. 3 shows a conventional on-line UPS power supply mode. As shown in FIG. 3, in such power distribution mode, the load may be supplied with power by two independent power supplies, i.e., the power grid or the UPS. Although the on-line UPS may supply power to the load by two independent power supplies Grid and UPS separately, the two independent power supplies still are unable to supply power to the load simultaneously, and a bi-directional flow of energy may not be achieved between the two independent power supplies.

FIG. 4 shows another on-line interactive UPS power distribution mode. As shown in FIG. 4, in the power distribution mode, the load may be supplied with power by two independent power supplies, i.e., Grid and UPS. The on-line interactive UPS may supply power to the load by two independent power supplies separately, and when any of the power supplies fails, the power supply to the load may be maintained; in a transition state of switching, or when a transient disturbance occurs in the power grid, the two independent power supplies may supply power to the load simultaneously for a short period. However, a bi-directional flow of energy may not be achieved between the two independent power supplies Grid and UPS.

In view of the above problems of the related art, a new power distribution system is demanded to solve the above problems.

### SUMMARY

An aspect of the present application is to provide a power distribution system and an electrical system with a plurality of power supplies and a load, through which: advantageously, in a state where any of the power supplies fails, the power supply to the load may be maintained; the power supply to the load may be switched smoothly between two power supplies; any one or two of the power supplies may be flexibly selected to supply power to the load and a ratio of energy drawn from each of the power supplies may be adjusted as desired; and bi-directional delivery of energy may be achieved between the two power supplies. Thereby, the economic benefit of the user may be maximized, and the power quality may be improved for the user. In addition, this unique power distribution configuration may not need substantial alteration to the existing power distribution configuration of the load and power supplies.

A first aspect of the present application provides a power distribution system, connected to a first power supply, a second power supply and an energy storage unit. The power distribution system includes:

a selection switch, having a movable terminal and a first fixed terminal, the movable terminal being connected to a load and selectively being electrically connected to the first fixed terminal;

a first converter, having a first terminal and a second terminal, the first terminal of the first converter being electrically connected to the second power supply;

a second converter, having a first terminal and a second terminal, the first terminal of the second converter being electrically connected to the second terminal of the first converter and electrically connected to the energy storage unit;

a first switch, having a first terminal and a second terminal, the first terminal of the first switch being electrically connected to the second terminal of the second converter, and the second terminal of the first switch being electrically connected to the first fixed terminal of the selection switch; and

a second switch, having a first terminal and a second terminal, the first terminal of the second switch being electrically connected to the second terminal of the first switch, and the second terminal of the second switch being electrically connected to the first power supply.

A second aspect of the present application provides an electrical system, including:

the above mentioned power distribution system; and

a measuring module, electrically connected to the first power supply and the power distribution system and configured to measure electrical information.

It is to be understood that both the foregoing general description and the following detailed description are exemplary and explanatory only and are not restrictive of the present application.

### BRIEF DESCRIPTION OF THE DRAWINGS

The accompanying drawings, which are incorporated in and constitute a part of this specification, illustrate embodiments consistent with the present application and, together with the description, serve to explain the principles of the present application.

FIG. 1 shows a conventional power supply and distribution mode with a single power supply for a load.

FIG. 2 shows a conventional power supply and power distribution mode with double power supplies for a load.

FIG. 3 shows a conventional on-line UPS power supply mode.

FIG. 4 shows another on-line interactive UPS power distribution mode.

FIG. 5 shows a power distribution system with a selection switch for a plurality of power supplies according to an embodiment of the present application.

FIG. 6 shows a power distribution system with a selection switch for a plurality of power supplies according to another embodiment of the present application.

FIGS. 7 and 8 are two conventional power distribution configurations for a household.

FIG. 9 is a first embodiment of the present application which is applied in household/industry.

FIGS. 10 and 11 are a second embodiment and a third embodiment of the present application which are applied in a household with a single-phase three-wire system.

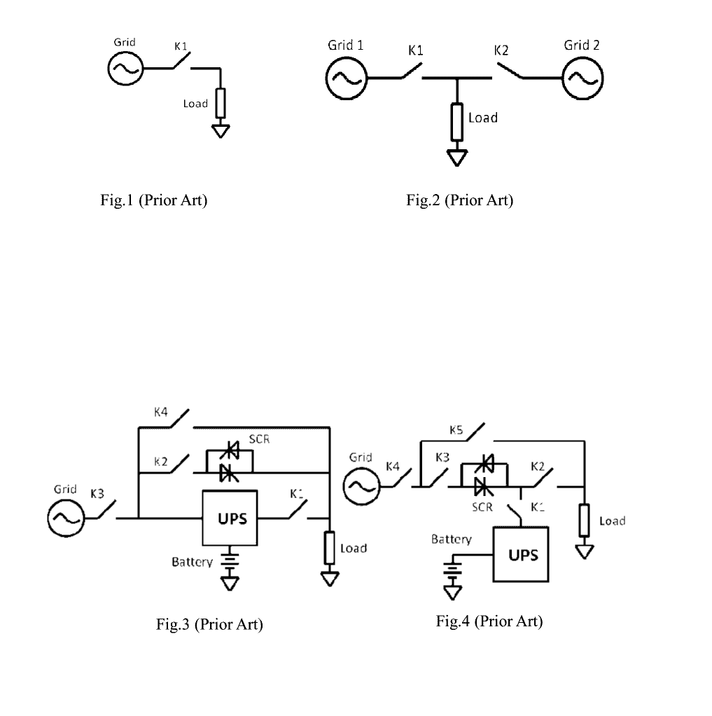

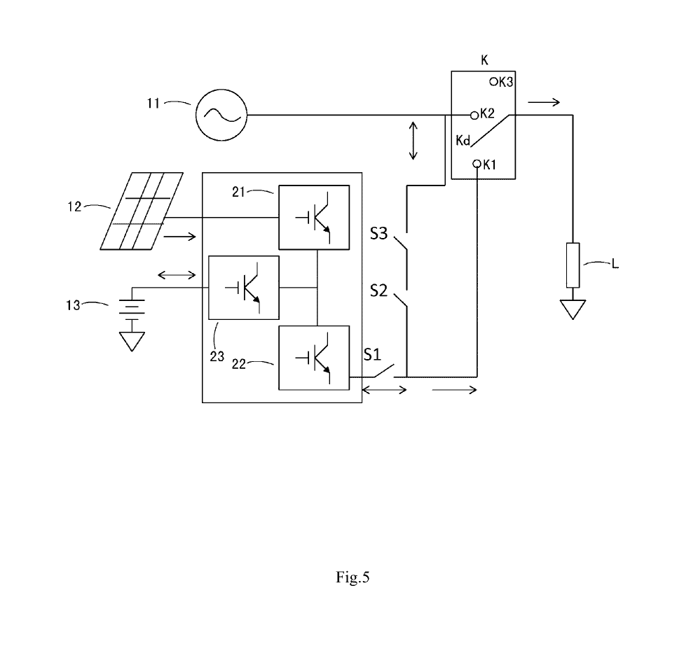

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the present application. Instead, they are merely examples of devices and methods consistent with aspects related to the present application as recited in the appended claims.

Other embodiments of the present application will be apparent to those skilled in the art from consideration of the specification and practice of the disclosure herein. This application is intended to cover any variations, uses, or adaptations of the present application following the general principles thereof and including such departures from the present application as come within known or customary practice in the art which the present application does not mention. It is intended that the specification and examples be considered as exemplary only, with a true scope and spirit of the present application being indicated by the claims.

The selection switch as mentioned herein may be a switch, or a set of switches, or a device, or a system which may achieve selection function, etc. For example, it may be a breaker, a relay, a hand brake or the like, or may be an integrated device containing a control chip or the like. However, the present application is not limited thereto. The fixed terminal of the selection switch herein may refer to a terminal of the selection switch at a side connected to a power supply or an energy storage device. The movable terminal of the selected switch may refer to a terminal of the selection switch at a side connected to a consumer. The expressions “movable” or “fixed” are only illustrative, and do not constitute restriction to specific movements of the terminals. The expressions “connection” or “electrically connection” herein may be either a direct connection or an indirect connection, or may be a connection by mechanic contact or non-mechanic contact. However, the present application is not limited thereto.

FIG. 5 shows a power distribution system with a selection switch for a plurality of power supplies according to an embodiment of the present application. Here, a single directional or bi-directional arrow indicates a possible flowing direction of energy. However, the present application is not limited thereto. As shown in FIG. 5, the power distribution system is connected to a first power supply 11, a second power supply 12 and an energy storage unit 13, to provide energy to a load L. The power distribution system includes a first switch S1, a second switch S2, a third switch S3, a selection switch K, a first converter 21, a second converter 22 and a third converter 23. In an embodiment, the third switch S3 may be omitted. However, the present application is not limited thereto.

It should be noted that, FIG. 5 is merely an illustration of the technical solution according to one embodiment of the present application, and is not a specific circuit diagram. Those skilled in the art may determine specific configuration based on the contents disclosed in FIG. 5. In addition, the first converter 21, the second converter 22 and the third converter 23 are illustrated merely for describe the technical solution of the present application, and not intended to limit the specific configuration of these converters.

In the present embodiment, the first power supply 11 is a power grid, the second power supply 12 is a solar battery panel i.e., PV panel, and the energy storage unit 13 is a storage battery, for example. It should be noted that these are merely for illustration and not for specific limitation. Those skilled in the art may made any modification or alteration without departing from the spirit of the present application. For example, the first power supply 11 may be any independent power supply, such as a power grid, a UPS, a diesel generator or the like, or combinations thereof; the second power supply 12 may be new kind of energy such as solar power, wind power, fuel cells or the like, or combinations thereof; and the energy storage unit 13 may be a storage battery of any kind, a super capacitor, a flywheel or the like, or combinations thereof. However, the present application is not limited thereto. The first power supply 11 may be an AC power source, the second power supply 12 may be a DC power source, the energy storage unit 13 may be a DC battery, the first converter 21 and the second converter 22 may be DC-DC converters, and the third converter 23 may be a DC-AC converter.

In the present embodiment, the selection switch K may be a single-pole three-throw switch, for example, the selection switch K has a movable terminal Kd, a first fixed terminal K1, a second fixed terminal K2 and a third fixed terminal K3. Each of the first switch S1, the second switch S2 and the third switch S3 may be bi-directional switch. However, the present application is not limited thereto. For example, in an embodiment, the second fixed terminal K2 and the third fixed terminal K3 may be omitted, and the first switch S1, the second switch S2 and the third switch S3 may be switches of other kinds, and so on.

The first power supply 11 and the second power supply 12 may be two independent power supplies for supplying power to the load L. The load L may be connected to the first power supply 11 and the second power supply 12 via the selection switch K. The movable terminal Kd of the selection switch K is connected to the load L and may selectively be electrically connected to the first fixed terminal K1 or the second fixed terminal K2. The first power supply 11 has an output terminal electrically connected to the second fixed terminal K2. An output terminal of the second power supply 12 may be electrically connected to a first terminal of the first converter 21. A second terminal of the first converter 21 may be electrically connected to a first terminal of the second converter 22. A second terminal of the second converter 22 may be electrically connected to a first terminal of the first switch S 1. The energy storage unit 13 may be connected to the first terminal of the second converter 22 either directly or via the third converter 23. However, the present application is not limited thereto. A second terminal of the first switch S1 may be electrically connected to a first terminal of the second switch S2. A second terminal of the second switch S2 may be connected to the first power supply 11 either directly or via the third switch S3 or other components. However, the present application is not limited thereto. In addition, the second terminal of the first switch S1 may also be connected to the first fixed terminal K1 of the selection switch K. The first converter 21, the second converter 22 and the third converter 23 may be integrated into one power conversion module.

The second switch S2 and the third switch S3 are connected in series, to serve as redundant gird connecting switches, that is, even if one of the switches fails, the other one may still serve as a breaker. Accordingly, in other embodiments, the third switch S3 may not be provided, and the second terminal of the second switch S2 may be directly connected to an output terminal of the first power supply 11. However, the present application is not specifically limited thereto.

In addition, in other embodiments, in case where the energy storage unit 13 may provide energy directly applicable to the circuit, the third converter 13 may not be provided, and the energy storage unit 13 may be directly connected to the first terminal of the second converter 22. However, the present application is also not specifically limited thereto.

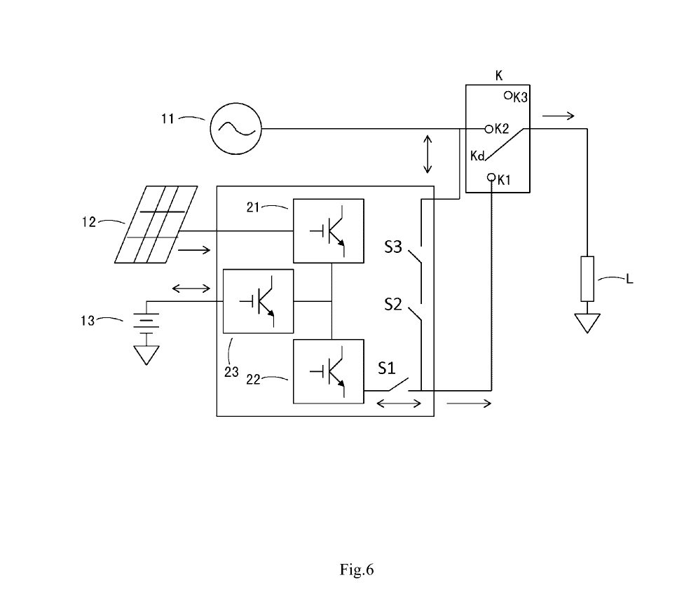

FIG. 6 shows a power distribution system with a selection switch for a plurality of power supplies according to another embodiment of the present application. Here, a single directional or bi-directional arrow indicates a possible flowing direction of energy. As shown in FIG. 6, in the present embodiment, the first converter 21, the second converter 22, the third converter 23, the first switch S1, the second switch S2 and the third switch S3 may be integrated into one power conversion module.

Hereinafter, an operation mode of the power distribution system will be described. However, the present application is not limited thereto.

In a first situation of the operation mode, i.e., a normal operation state, each of the first power supply 11 and the second power supply 12 normally outputs energy, the movable Kd of the selection switch K is electrically connected to the first fixed terminal K1, each of the first switch S1, the second switch S2 and the third switch S3 is switched on, the first power supply 11 and the second power supply 12 supply power to the load L via the first fixed terminal K1 of the selection switch K, and energy may be delivered bi-directionally between the first power supply 11 and the second power supply 12. Here, the third switch S3 may be omitted. A ratio of energy drawn by the load L from the first power supply 11 to that from the second power supply 12 may be controlled through the power conversion module, so as to maximize the economic benefit of the power consumption of the load. Since adjusting the ratio of energy drawn from the first power supply 11 to that from the second power supply 12 through the power conversion module is well known by those skilled in the art, it will not be described in detail herein.

In a second situation of the operation mode, i.e., a first operation state, the second power supply 12 operates normally, and the first power supply 11 does not output energy (including but not limited to failure, interruption of power supply, no power demand, incapable of outputting energy, or the like). The power conversion module may switch off the second switch S2 and/or the third switch S3 as desired, for example, according to a grid connecting requirement (island or low voltage ride through), so as to block the influence to the load L from the first power supply 11. The second power supply 12 continues providing power to the load L via the first switch S1. When the first power supply 11 is capable of outputting energy, the power conversion module may switch on the second switch S2 and the third switch S3 again upon detecting that the first power supply 11 has resumed to a set threshold, so as to resume two independent power supplies to supply power to the load L. However, the present application is not limited thereto. Here, the third switch S3 may be omitted.

In a third situation of the operation mode, i.e., a second operation state, the first power supply 11 operates normally, and the second power supply 12 does not output energy (including but not limited to failure, interruption of power supply, no power demand, incapable of outputting energy, or the like). The first switch S1 is switched off, the second switch S2 and the third switch S3 are switched on, so as to block the influence to the load L from the second power supply 12. The first power supply 11 continues providing power to the load L via the second switch S2 and the third switch S3. When the second power supply 12 is capable of outputting energy, the first switch S1 is switched on again, so as to resume two independent power supplies to supply power to the load L. Alternatively, when the second power supply 12 does not output energy and the first power supply 11 operates normally, the second switch S2 and the third switch S3 may also be switched off and the movable terminal Kd of the selection switch K may be electrically connected to the second fixed terminal K2, thus the first power supply 11 may continue providing power to the load L via the selection switch K. When the second power supply 12 is capable of outputting energy, the second switch S2 and the third switch S3 are switched on again, and the movable terminal Kd of the selection switch K is electrically connected to the first fixed terminal K1 again, so as to resume two independent power supplies to supply power to the load L. Here, the third switch S3 may be omitted.

When both of the first power supply 11 and the second power supply 12 do not normally operate, or need to be shut down for maintenance, the movable terminal Kd of the selection switch K is electrically connected to neither of the first fixed terminal K1 and the second fixed terminal K2, and the load L is disconnected with each of the power supplies 11 and 12. At this time, a third fixed terminal K3 may be provided for the movable Kd to be connected to. However, the present application is not limited thereto.

The energy storage unit 13 may draw energy from the first power supply 11 and/or the second power supply 12 when the first power supply 11 and/or the second power supply 12 operate normally, or provide output energy together with the first power supply 11 and/or the second power supply 12, or may feedback energy to the first power supply 11, or provide output energy alone. However, the present application is not limited thereto. For example, as shown by the bi-directional arrow in FIG. 6, energy may flow from the first power supply 11, through the third switch S3, the second switch S2, the first switch S1, the second converter 22 and the third converter 23, into the energy storage unit 13, or flow in a reverse direction.

In an embodiment, the selection switch K may be a switch of various kinds, for example, a single-pole three-throw switch, a double-pole three-throw switch, a three-pole three-throw switch, or the like, depending on the electrical configuration, or may be a single-pole double-throw switch, a double-pole double-throw switch, a three-pole double-throw switch, or the like. In addition, the first converter 21 may be a DC/DC converter, an AC/AC converter, or the like, depending on the type of the renewable energy. The second converter 22 may be an inverter of various kinds, including but not limited to a single-phase inverter, a three-phase inverter, an H5 inverter, an H6 inverter, a two-level inverter or a three-level inverter. The third converter 23 may be a DC/DC converter, an AC/AC converter, or the like, depending on the use of the energy storage unit 13. However, the present application is not limited thereto.

In the present application, the load L may be a load for various industries or households, and the like. FIGS. 5 and 6 are merely single-line diagrams illustrating electrical configuration. In practical application, these lines may be, for example, a combination of a DC bus including positive, negative and zero lines, or an AC single-phase two-wire system including L and N lines, or a single-phase three-wire system including L1, L2 and N lines, or a three-phase three-wire system including R, S and T lines, or a three-phase four-wire system including R, S, T and N lines, and the like.

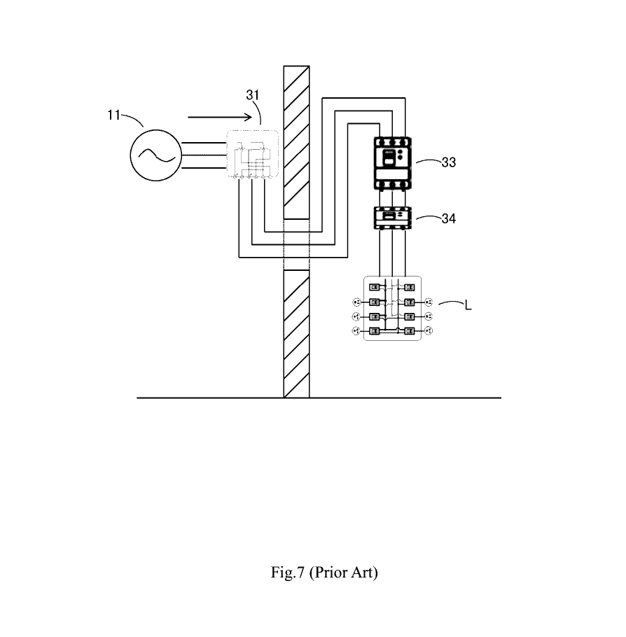

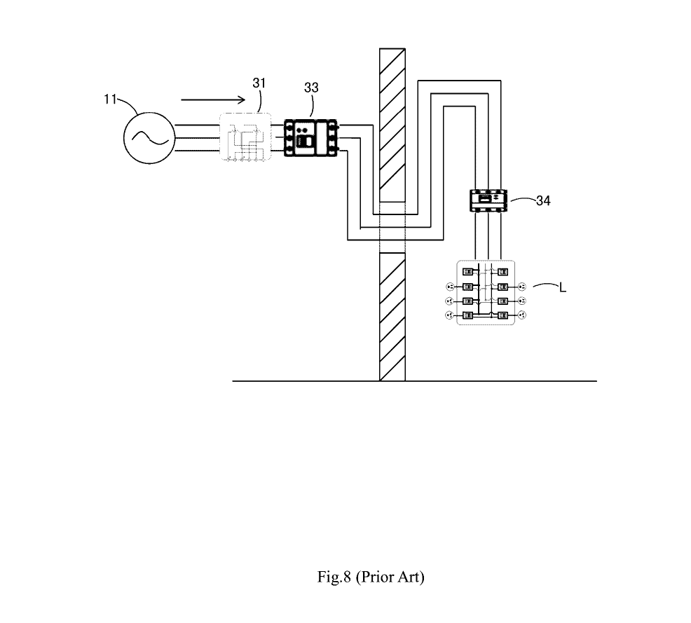

The above-mentioned power distribution system may be applied in an industry or in household. Here, a single-phase three-wire household application will be described as an example. FIGS. 7 and 8 are two conventional power distribution configurations for a household. As shown in FIG. 7, the first power supply 11 such as commercial power supply enters a household via an electricity meter 31 and through a wall indicated by a shade of oblique lines, then connects a capacity limiting breaker 33 of an electricity company, and then connects a leakage protection circuit breaker 34 in the household, and finally connects to a consuming load L in the household. It should be noted that, the capacity limiting breaker 33 of the electricity company may not necessarily be disposed indoor, and may be disposed outdoor or even may not be provided. As shown in FIG. 8, the capacity limiting breaker 33 is disposed outdoor. These two configurations are substantially the same for the indoor circuit, and three power wires including L1, L2 and N lines of a single-phase three-wire system are connected indoor.

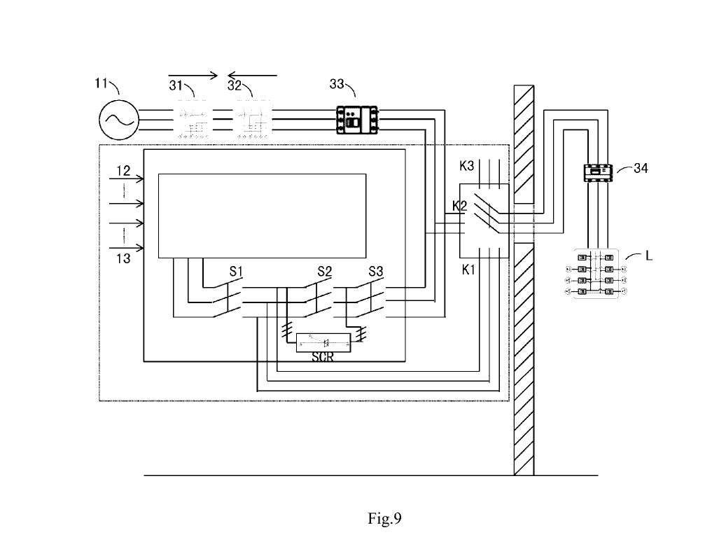

FIG. 9 is a first embodiment of the present application which is applied in a household with a single-phase three-wire system. As shown in FIG. 9, in order to improve reliability and quality of power supply for the user, and improve the economy benefit in usage of the electricity power, save energy and protect environment, the second power supply 12, a third power supply 13 and the power conversion module including the above-mentioned first converter 21, the second converter 22, the third converter 23, the first switch S1, the second switch S2 and the third switch S3, for example may be connected to a household through the power distribution configuration according to the embodiment of the present application. It can be seen, the power distribution configuration may require no substantial alteration to the original power distribution configuration in the household. That is, only a part in a dash-line box as shown in FIG. 9 is inserted between the capacity limiting breaker 33 of the electricity company and the leakage protection circuit breaker 34, and the part disposed indoor may be completely the same to that shown in FIG. 8. For a single-phase three-wire system, three wires are also required to be connected indoor. Therefore, it is easy to upgrade the existing household power distribution system. However, the present application is not limited thereto. Since the second power supply 12, the energy storage unit 13 and the power conversion module are provided, the energy at the side of the first power supply 11 may flow bi-directionally. Therefore, depending on the billing needs, in an embodiment, the electricity meter may be a bi-directional electricity meter. As shown in FIG. 9, the electricity meter may contain a first electricity meter 31 and/or a second electricity meter 32. However, the present application is not limited thereto. In addition, the power conversion module including the above-mentioned first converter 21, the second converter 22, the third converter 23, the first switch S1, the second switch S2 and the third switch S3, may be disposed at various positions in the electricity system. The present application is not limited thereto.

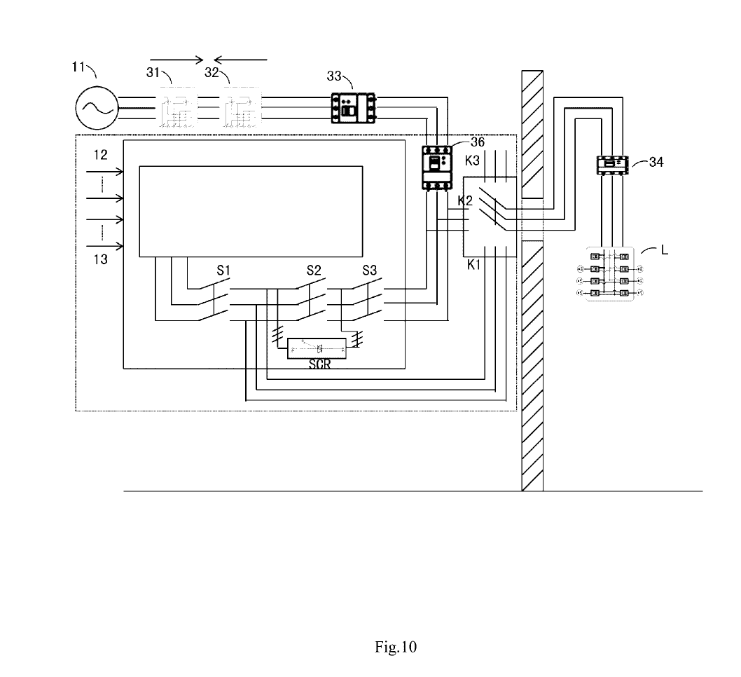

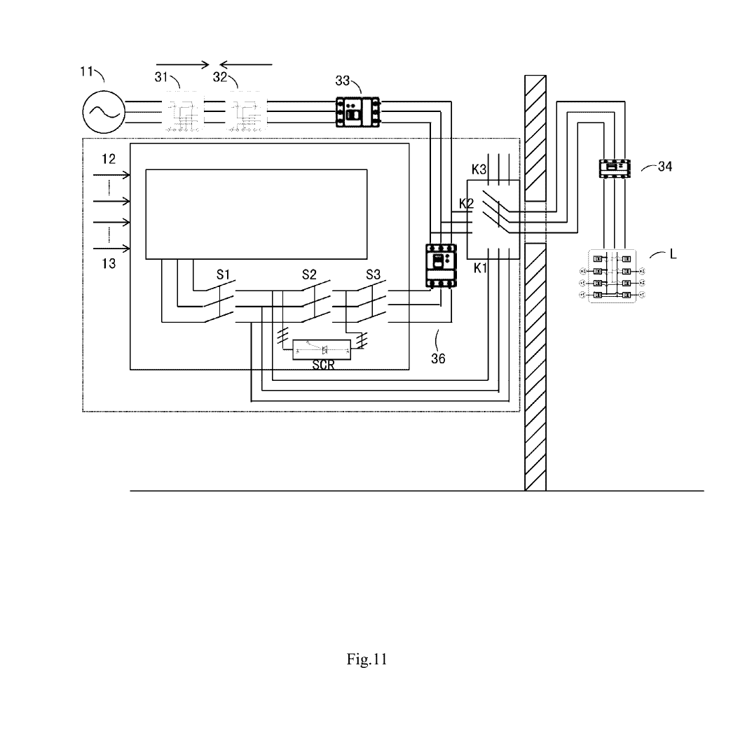

FIGS. 10 and 11 are a second embodiment and a third embodiment of the present application which are applied in a household with a single-phase three-wire system. According to regulations of some countries or districts, it is required to connect a photovoltaic connection circuit breaker between a photovoltaic power generation system and a power grid when the photovoltaic power generation system is connected to the power grid. For the application as shown in FIG. 9, a photovoltaic connection circuit breaker 36 may be connected between the capacity limiting breaker of an electricity company (as shown in FIG. 10) and the second fixed terminal K2 of the selection switch (i.e., a position of the photovoltaic connection circuit breaker 36 as shown in FIG. 10), or between the third switch S3 (as shown in FIG. 11) and the second fixed terminal K2 of the selection switch (i.e., a position of the photovoltaic connection circuit breaker 36 as shown in FIG. 11), and so on. It should be further noted that, in the power conversion module, a fast switch such as a silicon controlled rectifier (SCR) or the like, may be connected in parallel with the second switch S2, to speed up the switching of the second switch S2. It is more advantageous for smooth switching between the two power supplies. However, the present application is not limited thereto.

The present application also provides an electrical system, including the above mentioned power distribution system and a first measuring module. The first measuring module may be the above-mentioned electricity meter 31, connected to the first power supply 11 and the above-mentioned power distribution system and configured to measure electrical information such as current, voltage, impedance, power, etc.

It should be understood that, the present application is not limited to the specific structure described above and illustrated in the drawings, and may be made various modification and alteration without departing from the scope thereof. The scope of the present application is merely limited by the appended claims.

What is claimed is:

1. A power distribution system, connected to a first power supply (11), a second power supply (12) and an energy storage unit (13), wherein the power distribution system comprises:
a selection switch (K), having a movable terminal (Kd) and a first fixed terminal (K1), the movable terminal (Kd) being electrically connected to a load (L) and selectively being electrically connected to the first fixed terminal (K1);
a first converter (21), having a first terminal and a second terminal, the first terminal of the first converter (21) being electrically connected to the second power supply (12);
a second converter (22), having a first terminal and a second terminal, the first terminal of the second converter (22) being electrically connected to the second terminal of the first converter (21) and electrically connected to the energy storage unit (13);
a first switch (S1), having a first terminal and a second terminal, the first terminal of the first switch (S1) being electrically connected to the second terminal of the second converter (22), and the second terminal of the first switch (S1) being electrically connected to the first fixed terminal (K1) of the selection switch (K); and
a second switch (S2), having a first terminal and a second terminal, the first terminal of the second switch (S2) being electrically connected to the second terminal of the first switch (S1), and the second terminal of the second switch (S2) being electrically connected to the first power supply (11).

2. The power distribution system according to claim 1, wherein the selection switch (K) further comprises a second fixed terminal (K2), the movable terminal (Kd) of the selection switch (K) selectively being electrically connected to the second fixed terminal (K2), and the first power supply (11) being electrically connected to the second fixed terminal (K2).

3. The power distribution system according to claim 2, wherein the power distribution system further comprises a third converter (23) located between the energy storage unit (13) and the second converter (22), the third converter has a first terminal and a second terminal, the first terminal of the third converter (23) is connected to the energy storage unit (13), and the second terminal of the third converter (23) is connected to the first terminal of the second converter (22).

4. The power distribution system according to claim 3, wherein the power distribution system further comprises a third switch (S3) located between the second switch (S2) and the first power supply (11), the third switch (S3) being electrically connected to the second switch (S2) and the first power supply (11).

5. The power distribution system according to claim 2, wherein in a second operation state, the first switch (S1) is switched off, or the second switch (S2) is switched off, or both of the first switch (S1) and the second switch (S2) are switched off; the movable terminal (Kd) of the selection switch (K) is connected to the second fixed terminal (K2), and the first power supply (11) is connected to the load (L) via the second fixed terminal (K2) .

6. The power distribution system according to claim 2, wherein the selection switch (K) further comprises a third fixed terminal (K3).

7. The power distribution system according to claim 1, wherein the power distribution system further comprises wires to achieve electrical connection, the wires being a DC bus-wire, or an AC single-phase two-wire, or a single-phase three-wire, or a three-phase three-wire, or a three-phase four-wire.

8. The power distribution system according to claim 1, wherein the power distribution system further comprises a third converter (23) located between the energy storage unit (13) and the second converter (22), the third converter has a first terminal and a second terminal, the first terminal of the third converter (23) is connected to the energy storage unit (13), and the second terminal of the third converter (23) is connected to the first terminal of the second converter (22).

9. The power distribution system according to claim 8, wherein the power distribution system further comprises:
a third switch (S3), connected to the second switch (S2) in series, the third switch (S3) having a first terminal and a second terminal, the second terminal of the second switch (S2) being electrically connected to the first terminal of the third switch (S3); the second terminal of the third switch (S3) being electrically connected to the first power supply (11), such that the second terminal of the second switch (S2) is electrically connected to the first power supply (11) via the third switch (S3).

10. The power distribution system according to claim 9, wherein the selection switch (K) further comprises a second fixed terminal (K2), the movable terminal (Kd) of the selection switch (K) selectively being electrically connected to the second fixed terminal (K2), and the first power supply (11) being electrically connected to the second fixed terminal (K2).

11. The power distribution system according to claim 9, wherein the first converter (21), the second converter (22), the third converter (23), the first switch (S1), the second switch (S2) and the third switch (S3) are integrated into a power conversion module.

12. The power distribution system according to claim 1, wherein in a first operation state, the second switch (S2) is switched off, the first switch (S1) is switched on, the movable terminal (Kd) is electrically connected to the first fixed terminal (K1), and the second power supply (12) is connected to the load (L) via the first switch (S1).

13. The power distribution system according to claim 1, wherein in a second operation state, the first switch (S1) is switched off, the second switch (S2) is switched on, the movable terminal (Kd) is electrically connected to the first fixed terminal (K1), and the first power supply (11) is connected to the load (L) via the second switch (S2).

14. The power distribution system according to claim 1, wherein the selection switch (K) further comprises a third fixed terminal (K3).

15. An electrical system, comprising:
the power distribution system according to claim 1; and
a measuring module (31), electrically connected to the first power supply (11) and the power distribution system and configured to measure electrical information.
